(19) United States
(12) Patent Application Publication
(10) Pub. No.: US 2014/0091565 A1
(43) Pub. Date: Apr. 3, 2014

(54) RECREATIONAL-BOARD FENDER AND SPLASH GUARD APPARATUS AND SYSTEM

(71) Applicant: Aeton Law Partners LLP, Middletown, CT (US)

(72) Inventors: Shane Feyers, New Haven, CT (US); Wade Moore, Trumbull, CT (US)

(21) Appl. No.: 14/044,865

(22) Filed: Oct. 2, 2013

Related U.S. Application Data
(60) Provisional application No. 61/708,943, filed on Oct. 2, 2012.

(51) Int. Cl. B62D 25/16; A63C 17/01

(52) U.S. Cl. CPC B62D 25/16; A63C 17/01
USPC 280/851

(57) ABSTRACT

The invention relates to a fender and splash guard device and system configured to be secured to either an axle or a truck of a recreational and personal boarding device including, but not limited to, skateboards, long boards, and or mountain boards thereby protecting the rider from any projecting debris or splashing when using the board. The fender and splash guard device and system can molded and or otherwise formed in a unitary construction or two piece construction.

This application relates to, benefits from, and claims priority from U.S. Provisional Application No. 61/708,943 filed on Oct. 2, 2013.

### FIELD OF THE INVENTION

The present invention relates to splash guards for recreational and personal boarding devices and, more particularly, to a fender configured to the truck or axel of a board fender.

### BACKGROUND OF THE INVENTION

A recreational and personal boarding device includes, but is not limited to, long boards, skateboards, and or mountain boards come in a variety of lengths and widths, shapes, and thicknesses. Recreational boarding devices generally have a board formed from wood, composite, or metals. The board is raised from the ground by two sets of trucks: one in the front and one on the rear; the trucks are affixed to the underside of the board. Wheels are attached to the trucks and, specifically, two pairs of wheels, left and right respectively. The boarding device can then be utilized for mobility.

Currently boarding devices are unfitted with any devices to protect a rider during variable weather events, road conditions, or environmental hazards. As a result, there is a need for an installed fender mounting system that can guard and protect the rider from any projecting debris or splashing when using the board for mobility. These splash guards would allow for users to have a more comfortable and less disruptive ride, drastically—if not entirely—reducing the solids or liquids hitting the user, their clothing, and their shoes. These recreational-board fenders will enable the rider to have a cleaner, drier ride to allow for more versatile use, in many weather conditions, to more destinations.

A variety of skateboard designs having caster-type and in-line wheel configurations with fenders have been adopted. Examples of such skateboards are set forth in U.S. Pat. No. 3,995,873 to Pantzar discloses a caster-type roller with fender is supported and secured to the underside of the board; U.S. Pat. No. 4,744,576 to Scollan, Jr. discloses a stability feature using fender exterior wheel assemblies arranged on lateral sides of the board and secured to a flexible, fiber reinforced plywood member; U.S. Pat. No. 4,817,974 to Bergeron shows a fender secured by an axle bolt covering a roller skate and skate board device; U.S. Pat. No. 6,431,568 B1 to McCleese discloses a fender plate covering multiple in-line wheels secured by an axle bolt; and U.S. Pat. No. 6,988,742 B2 to Jonsson et al. shows a braking system covering in-line wheels secured by an axle bolt in a similar location. The fender arrangement of each of these patents differ from the present invention; none of these assemblies are made, attached or function in a manner suitable for a recreational and personal boarding.

As a result, there is a need for a fender and splash guard apparatus and system of the present invention and, in particular, a splash guard apparatus and system providing improved efficiencies, flexibility, durability, reliability in the recreational and personal boarding devices environments. In particular, known fender systems have not been adapted for recreational and personal boarding device environments with wheels of the board using a truck-stem type mounting system of modern board systems. Moreover, the fender system of the present invention does not act as a primary supporting piece and is independent of the board being mounted to a truck stem rather than mounted by a bolt to the axle, which is stationary.

### SUMMARY OF THE INVENTION

It is an object of the present invention to provide an improved assembly for a board platform, comprising an elongated deck formed having an upper surface and a lower surface; one or more wheels rotatably mounted on a truck to the lower surface of the elongated deck; and a fender configured with a support for mounting to the truck and adjacent the wheels for protecting the rider from any projecting debris or splashing when using the board.

The splash-guards of the present invention are configured advantageously to be convexly contoured metal or plastic flat stock; shaped to surround the upper portion of each individual wheel, with a gap (between the wheel and the fender) high enough to prevent contact during riding and maneuvering; positioned a sufficient distance from the board and trucks to allow for unimpeded mobility, while still remaining effective in capturing debris or liquids.

It also is an object of the present invention to provide a fender and splash guard assembly and system configured to attach to the fender frame, mounted by way of screw, using the below described methods and form.

It is an object of the present invention to provide an apparatus, system and method formed of a durable material, semi flexible, and resistant to wear such as injection molding, plastic and or metal—although any compound to create the fender system.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Description of the Embodiments, which is to be read in association with the accompanying drawings, which are incorporated in and constitute a part of this specification, show certain aspects of the subject matter disclosed herein and, together with the description, help explain some of the principles associated with the disclosed implementations, wherein:

FIG. 1 illustrates a perspective view of a splash guard and fender apparatus and system in accordance with an embodiment of the present invention;

FIG. 2 illustrates a side view of a splash guard and fender assembly for a skateboard in accordance with the invention;

FIG. 3 illustrates a bottom view of a splash guard and fender apparatus and system;

FIG. 4 illustrates a side view of a splash guard and fender apparatus and system;

FIG. 5 illustrates an opposite side of a splash guard and fender assembly for a skateboard as shown in FIG. 2;

FIG. 6 illustrates a perspective view of a truck and the attachment point;

FIG. 7 is a perspective of the recreational-board fender system splash guard in accordance with the invention;

FIG. 8 is a front view perspective of the recreational-board fender system splash guard;

FIG. 9 is a back view perspective of the recreational-board fender system splash guard;

FIG. 10 is a side view perspective of the recreational-board fender system splash guard;

FIG. 11 is a side view perspective of the recreational-board fender system splash guard;

FIG. 12 is a top view perspective of the recreational-board fender system splash guard; and

FIG. 13 is a bottom view perspective of the recreational-board fender system splash guard.

### DESCRIPTION OF THE EMBODIMENTS

Non-limiting embodiments of the present invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are provided for the purposes of illustrating some embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “board” refers to a board or elongated surface with wheels used as a recreational and personal boarding device including, but not limited to, skateboards, long boards, and or mountain boards that can come in a variety of lengths and widths, shapes, and thicknesses. The “board” usually consists of a specially designed maple wood board combined with a polyurethane coating used for making smoother slides and stronger durability although other materials and laminate constructions can be utilized. A skateboard can be flat or curved where the curved concave upper surface enables a rider to perform tricks. Skateboard decks are usually between 28 and 33 inches (71.12 and 83.82 centimeters); a long board has a longer deck. A mountain board or slalom board is a skateboard, usually 60-80 cm long, with great maneuvering capability. Accordingly, as can be understood by one having ordinary skill in the relevant art, a recreational and personal boarding device has a truck assembly and wheels suspended on the underside of the board. The present invention provides a wheel covering fender around each individual wheel so as to keep liquids and debris from splashing or projecting onto the user of any skate, long, or mountain board.

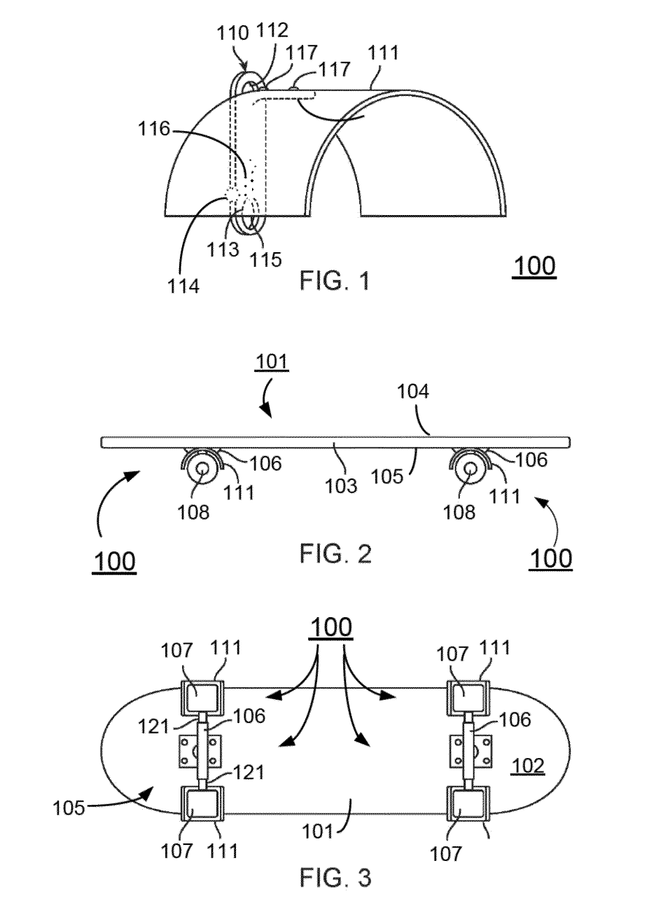

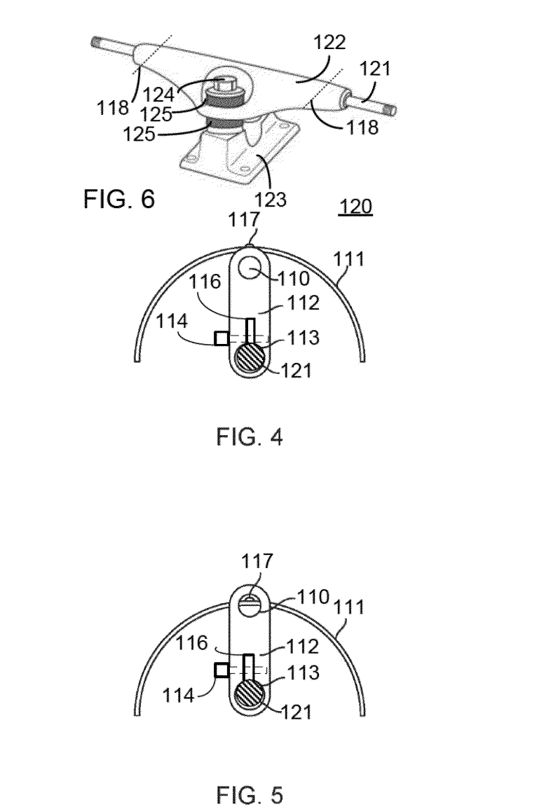

As is illustrated in FIGS. 1-5 and 6, one embodiment of a recreational and personal boarding device according to the present invention is described. Various modifications, however, will remain readily apparent to those skilled in the art, since the general principles of the present invention have been defined and specifically provide for an improved and simplified modified fender and splash guard system 100 for a board 101 such as a skateboard, long board, mountain board or the like. For reasons of explanation only, and not by way of limitation, the fender and splash guard system 100 will be described in connection with a flat decked skateboard, generally indicated at 102.

As is illustrated in FIGS. 2 and 3, the board 101 is configured generally with an elongated surface or deck 103 with a top or upper surface 104 and a bottom or lower surface 105. The upper surface 104 is configured to support the boarder or user. The lower surface 105 is used to attach a truck 106, typically two, adapted to receive on an axle 121 a wheel 107 and bearing 108, typically four are required, to the deck 103 using mounting hardware 109.

As is illustrated in FIGS. 3 and 6, skateboard trucks 106, and truck assembly 120, are generally T-shaped pieces mounted to the lower surface 105 of the deck 103. A skateboard 102 typically has two trucks 106 attached to the deck by the mounting hardware 109. The wheels 107 and bearings 108 are connected to the deck 103. Trucks 106 are manufactured usually from metals including aluminum alloys.

Referring now to FIGS. 1-3, a skateboard 102 is illustrated, although it should be understood that various components may be differently constructed or arranged without departing from the spirit of the invention. The splash guard rim 111 is attached to the truck 106 with a support arm 112 that has a hole 113 configured to pass onto an axle 121 of the truck assembly 120 there-through by taking off the wheel 107 of the skateboard 102, sliding the hole 113 of support arm 112 onto the axle 121.

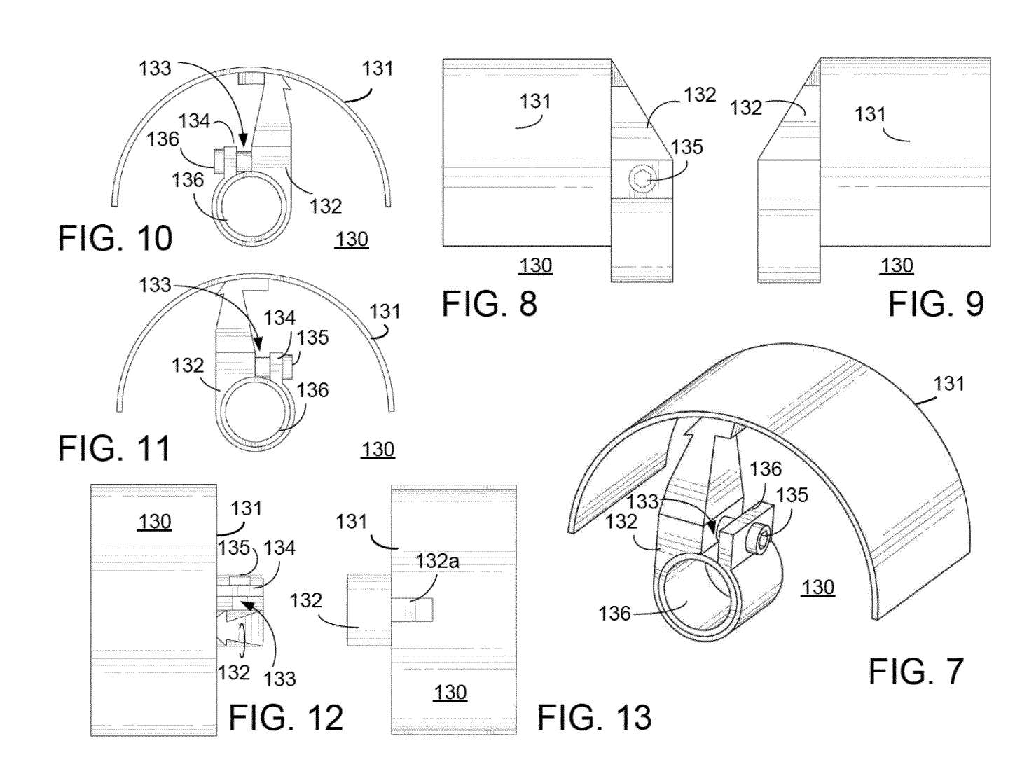

Referring to FIGS. 1, 4 and 5, the support arm 112 includes a slot 116 extending upwardly from the hole 113 that is cut or otherwise formed in the support arm 112. A hole is drilled from across the slot 116 in the side of the support arm 112 for a fastener 114. The fastener 114 extends through and across the slot 116 into the support arm 112 portion on the opposite side of the slot 116. By tightening the fastener 114, the slot 116 size is reduced, the hole 113 reduces, pinches and clamps around the axle 121 of the truck 106. In this manner, the assembly 110 can be secured in a vertical orientation around the axle 121 to dispose the rim, fender or splash guard 111 adjacent the wheel 107. A rubber lining 115 also can be utilized around the axle 121 such that tightening of the fastener 114 secures the hole 113 and the support arm 112 to the axle 121 with the lining 115 there-between. The lining 115 varies can vary in size to accommodate different skateboard truck diameters and roundness. The rim 111 is connected to the support arm by two screws 117 which screw the rim 111 into a pin 116 that runs through an aperture in clamp 18. FIGS. 1-5 illustrate the clamp feature of the fastener 114 and slot 116 to secure the fender and splashguard assembly 110 around axle 121, as well as is illustrated in the alternative method of securing the assembly 130 at the attachment location 118 of the hanger 122 to trucks 106 as is disclosed in the alternative embodiment of FIGS. 7-13.

The fender and splashguard assembly 111 enhances any skate, long, or mountain board 101 by providing a wheel 107 covering assembly 110 around each individual wheel 107 so as to keep liquids and debris from splashing or projecting onto the user of the board 101. The rim 111 can be manufactured of convexly contoured metal or plastic flat stock; shaped to surround the upper portion of each individual wheel 106 and configured with a predetermined gap (between the wheel 106 and the rim 111) sufficient to prevent contact during riding and maneuvering; and positioned a sufficient lateral distance from the board 101 and trucks 106 to allow for unimpeded mobility, while still remaining effective in capturing debris or liquids. The fender assembly and system can attach either (1) to the axle 121, as shown in FIG. 1, 4 and 5, or (2) to the truck 106 as is discussed in FIGS. 7-13. The assembly 110 can be positioned at location 118 around the truck hanger 118 using the metal frame to slide over the hanger 122 by clamping using fastener 135 and clamp 134. The rubber lining 136, or similar structure or material having improved friction qualities, can ensure the assembly 110 has sufficient surface contact to remain in position. The fender and splash guard assembly 110 can be formed of a durable material, semi flexible, and resistant to wear such as plastics, metal or other suitable compounds and materials.

The fender and splashguard assembly 110 can be can be permanently left on the skateboard trucks 107, or axel 121, or easily removed by the skateboard operator by unscrewing the clamp screw 114 or 135. Alternatively, the upper rim can be made detachable from the support arm 122 by a locking configuration for quick removal of the splashguard rim 111 when desired, for example, good weather conditions. The attachment would allow the user to take off the splashguard rim without removing the wheels, so as to not interfere with the general appearance during conditions where the use of the fender assembly is not preferred. The rubber lining 115, or 136 herein, also can vary in size to accommodate different skateboard truck diameters and roundness. The screws 117 can be a pan head type screw to allow adequate clearance for skateboards with the wheels position directly under the bottom of the skateboard. The fender and splashguards assembly 110 is designed to allow the user to operate the skateboard 103 without reducing the normal range of motion available when turning.

Referring to FIG. 6, a truck assembly 120 is composed of two or more parts typically having an axle 121 disposed in a hanger 122, the hanger 122 being secured to a base plate 123 by a kingpin 124 with bushing(s) 125 disposed there-between for mobility and shock absorption. The axle 121 is disposed within, or otherwise runs through, the hanger. The axle 121 is typically a pin that runs through the hanger 122 of the truck assembly 120 and is configured to attach the wheels 107 and bearings 108 thereto. The hanger 122 is usually configured in a somewhat triangular in shape and constructed from metal such as, for example, steel or aluminum alloys. The base plate 123 attaches to the bottom or lower surface 105 of a deck 103 by the mounting hardware 109 through a plurality of holes for the mounting hardware. The kingpin 124 is the large bolt, for example, typically ⅜″, that holds these parts together and fits inside the skateboard bushings 125.

The top part of the truck 106 is the base plate 123, which is screwed to the deck 103 by the mounting hardware 109; located beneath the base plate 123 is the hanger 122. The axle 121 runs through the hanger 122. The kingpin 124, which can be a bolt, holds the truck assembly 120 together and fits inside the bushings 125, for example, dimensioned to a ⅜″ nut size. Between the base plate 123 and the hanger 122 are bushings 125, which also can be rubbers or grommets that provide the cushion mechanism for turning the skateboard 102. The bushings 125 cushion the truck 106 when turning and stiffer bushings 125 result in a skateboard 102 more resistant to turning. The softer the bushings 125, the easier it is to turn. In operation, by tightening or loosening the nut fastener of the kingpin 124, the truck assembly 120 can be adjusted for better turning and, alternatively for stability.

Referring to FIG. 6, According to the present invention, the fender and splash guard 100 is adapted to secure to the truck 106 adjacent the wheel 107 and axle 121 at attachment location 118 on the hanger 122 of the truck assembly 120. The fender and splash guard 100 can be attached can be disposed on either side of the truck assembly 120 at attachment location 122 so as to provide a fender or splash guard for each wheel 107. The attachment location 122 on the hanger 122 advantageously provides a high degree of surface to secure the arm support 112 of the fender 111 to the hanger 122. Advantages also include providing a connection location away from objects and jolts originating from the outside of the board 101. This connection location further reduces or minimizes the prospect for other types of stress to the fender 100 that can dominate during use of the board 101, thereby such connection location being optimized with regard to these stresses. In this manner, the fender 100 design of the present invention provides an improved device and system adapted to keep liquids and debris from splashing or projecting onto the user of the board 101.

Mounting hardware 109 is used to connect the trucks 106 to the deck 103. The mounting hardware 109 can be from a variety of fastening means including nuts, bolts, locknuts and screws, Allen or Phillips head, and come in many different lengths. The mounting hardware secures the base plate 123 to the deck 103. Typically, a set of mounting hardware 109 for a skateboard 102 includes 8 bolts and 8 locknuts for the two trucks 107.

Referring to FIGS. 7-13, a molded fender 130 embodiment of the present invention is shown. Generally, the molded fender 130 includes a rim, fender or splash guard 131 connected to an arm or support 132 with a slot 133 forming an integral clamp 134 tightened by fastener 135. The clamp 134 is configured to surround and secure the molded fender 130 to the hanger 122 of truck assembly 120. A rubber lining 136 is placed around the hanger 122 at attachment location 118 as is shown in FIG. 6. The clamp 134 is located to surround the rubber lining 136 disposed on the hanger 122, which can be accomplished, for example, by removing the wheel 107. The molded fender assembly 130 is affixed and secured to the hanger 112 by tightening fastener 135 of clamp 136.

The molded fender 130 advantageously reduces the manufacturing steps, material costs, assembly and component parts of the fender device and system 100 of the present invention. The molded fender 130 can be a unitary or one-piece construction formed from plastics, metal such as, for example, steel or other alloys. For example, the unitary, one-piece construction rim 131, support arm 132, slot 133, clamp 134 and hole for the fastener can be milled by a computer numeric control from a piece of material. The hole can be tapped for threads for a fastener 135, such as, for example, a screw 135 or untapped utilizing a self-tapping screw 135. Fender and splash guard assembly 100 can be configured as a kit with the components of the molded fender 130, the fastener 135 and rubber lining 136, whereby the user assembles the kit components on the hanger 122 of a board 101. Alternatively, a two-piece construction of (1) the rim, fender or splash guard 111; and (2) the support arm 132 with integral clamp 134 and slot 133 can be formed separately in a two-piece configuration. The rim 131 can be secured to an upper portion 132a, as shown in FIG. 13, of the support arm 132 by adhesives, welding, press fittings, screws, rivets, and/or integral clips for removability as desired, and as is advantageous to assembly and manufacture.

While certain configurations of structures have been illustrated for the purposes of presenting the basic structures of the present invention, one of ordinary skill in the art will appreciate that other variations are possible which would still fall within the scope of the appended claims. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An improved assembly for a board platform, comprising:
an elongated deck formed having an upper surface and a lower surface;
one or more wheels rotatably mounted on a truck to the lower surface of the elongated deck; and
a fender and splashguard assembly comprises a support arm having with an integral clamp and a rim, said and fender and splashguard assembly adapted to be mounted adjacent said wheels for protecting the rider from any projecting debris or splashing when using the board.

2. The assembly of claim 1 wherein the fender is configured from a unitary or one-piece construction.

3. The assembly of claim 1 wherein the fender is configured from a two-piece construction.

4. The assembly of claim 2 wherein the support arm and rim are secured together by welding, adhesives and the like.

5. The assembly of claim 1 wherein said integral clamp mounts said fender and splashguard assembly to an axle of a truck assembly.

6. The assembly of claim 1 wherein said integral clamp mounts said fender and splashguard assembly to a truck.

7. A fender kit for a recreational board assembly, the kit comprising:
a fender and splashguard assembly comprises a support arm having with an integral clamp and a rim, said fender and splashguard assembly adapted to be mounted adjacent said wheels for protecting the rider from any projecting debris or splashing when using the board; and
a fastener configured to be received in a hole formed in the clamp, whereby said fastener can tighten and reduce the slot to mount said fender and splashguard assembly adjacent said wheels.

8. The kit of claim 8 wherein said fender and splashguard assembly is made of a unitary construction.

9. The kit of claim 8 wherein said fender and splashguard assembly is made of a two-piece construction.

10. The kit of claim 8 further comprising a rubber lining adapted to be disposed between the truck and the clamp of said fender and splashguard assembly, where by the rubber lining creates a secure attachment location to the truck.
